(19) United States
(12) Patent Application Publication
(10) Pub. No.: US 2008/0209826 A1
(43) Pub. Date: Sep. 4, 2008

(54) COMPOSITE DOORS

(76) Inventors: David Kenneth Hodges, Malvern (GB); Vincent Conroy, Axminster (GB)

Correspondence Address: KING & SCHICKLI, PLLC, 247 NORTH BROADWAY, LEXINGTON, KY, 40507, US

(21) Appl. No.: 12/041,066

(22) Filed: Mar. 3, 2008

Related U.S. Application Data
(60) Provisional application No. 60/893,172, filed on Mar. 6, 2007.

(30) Foreign Application Priority Data
Mar. 3, 2007 (GB) 0704181.7

(51) Int. Cl. E06B 3/20

(52) U.S. Cl. 52/204.7; 52/784.1

(57) ABSTRACT

According to the invention there is provided a composite door including a first and a second door skin, each door skin having an interior and an exterior surface, in which the interior surface of at least the first door skin has one or more bosses formed therein for receiving a fastening element.

This application claims the benefit of U.S. Provisional Patent Application Ser. No. 60/893,172, filed Mar. 6, 2007, and United Kingdom Application No. 0704181.7, filed Mar. 3, 2007, the disclosures of each of which are incorporated herein in their entirety by reference.

### FIELD OF THE INVENTION

This invention relates to composite doors, glazing panel retention means and door skins.

### BACKGROUND OF THE INVENTION

Composite doors are doors having main bodies which are formed from more than one material, and can be contrasted with traditional doors such as timber doors. One example of a composite door is the type that utilises a pair of plastic door skins, such as is taught in GB 2267529. The door skins are mounted on a frame and panels of a suitable material are located within the frame between the door skins. It is also known to produce composite doors in a single moulding process.

It is commonly desired to provide doors having glazing apertures in which a glass panel or like is disposed. Typically a panel consisting of two panes of glass which are spaced apart by and mounted on one or more spacer members is utilised. The term “glazing panel” is used herein to describe any pane or panel which is used for glazing purposes, and can comprise one or more than one individual panes. It is well known to provide a glazing cassette in which the glazing panel is retained, the glazing panel being installed in a door using well known techniques. Typically, the glazing cassette comprises two frame members, one of which is provided with a plurality of plugs, and the other of which is provided with a plurality of corresponding apertures. The frame members are coupled together so as to retain a glazing panel disposed therebetween. This is done by positioning the plugs in the corresponding apertures, and fixing it in place using screws which are screwed into the plugs. Afterwards, a cap is positioned over the screw heads. This procedure is time consuming and somewhat difficult to perform. Additionally, the end result is not aesthetically pleasing. Further problems associated with cassette systems are that they are typically expensive, relatively insecure, and, since they may be constructed of different materials to the outer surface of the door, can result in differential patterns of weathering. Further still, traditional cassette systems stand proud of the surface of the door when fitted. Internal glazing reinforcement mechanisms which are positioned between the door skins of a composite door are known, but the mechanisms can be costly, necessitate the use of relatively small glazing panels, and can be time consuming to construct. An internal glazing reinforcement mechanism is disclosed in EP 1505245. In order to install a glazing panel in the doors disclosed in EP 1505245 it is necessary to form a substantial recess in the door by cutting or milling as part of the installation process.

The present invention, in at least some of its embodiments, addresses the above described problems.

### SUMMARY OF THE INVENTION

According to a first aspect of the invention there is a provided a composite door including a first and a second door skin, each door skin having an interior and an exterior surface, in which the interior surface of at least the first door skin has one or more bosses formed therein for receiving a fastening element.

The provision of the one or more bosses enables glazing panels to be fitted to a composite door very conveniently. In addition to the fixing of the glazing panels, other hardware fixing, such as letter plates and door knockers, might be installed in a composite door of the first aspect of the invention.

Very conveniently, the door skins are moulded, and the one or more bosses are in the form of mouldings. Preferably, the door skins are moulded from sheet moulding compound (SMC). It has been found that SMC door skins have a strength which is particularly well suited to the present invention, enabling hardware fixings to be attached in place reliably.

In preferred embodiments, the one or more bosses are adapted to receive a threaded fastening element, preferably a screw or threaded insert.

The composite door may be glazed, and may further include: a glazing panel disposed in a recess in the door; and at least one glazing panel retention means for retaining the glazing panel in the recess, in which the at least one glazing panel retention means is secured to a plurality of bosses in the first door skin by respective fastening elements. Advantageously, the interior surface of the first door skin has an aperture formed therein, which aperture is surrounded by a glazing panel receiving surface against which the glazing panel is retained.

In a preferred embodiment, the fastening elements have an elongate body portion, and a glazing panel retention means includes one fastening element receiving portion having an elongate channel for receiving the elongate body portion of a fastening element, and a surface for engaging and retaining the glazing panel.

In a preferred embodiment, the composite door includes a plurality of glazing panel retention means in the form of a plurality of clips. In other embodiments, a glazing panel retention means includes a plurality of fastening element receiving portions which are linked by connecting portions. For example, the glazing panel may be retained by a single glazing panel retention means in the form of a frame member including a plurality of fastening element receiving portions.

Alternatively, the glazing panel retention means may be in the form of a boelection formed on the interior surface of the second door skin and including a plurality of fastening element receiving portions.

Advantageously, the at least one glazing panel retention means is moulded. Conveniently, the at least one glazing panel retention means is injection moulded. Moulded glazing panel retention means are economical to produce and also have the advantages that it is possible to manufacture a precisely defined shape of precisely defined dimensions. Additionally, it is convenient to produce relatively complex shapes. This can be contrasted with prior art glazing panel retention means fabricated from materials such as timber and metal, which require complex machining or processing in order to achieve precise shapes and dimensions.

Advantageously, the composite door further includes a trim which is coupled to the glazing panel retention means in the vicinity of the second door skin. An advantage associated with the present invention is that the trim can be positioned to be substantially flush with the exterior surface of the second door skin.

Preferably, the glazing panel retention means and the trim include engageable portions allowing the trim to be retained in the glazing panel retention means. In one embodiment, the trim includes a plurality of projections for locating in the elongate channels of the glazing panel retention means.

Additionally or alternatively, the trim may include one or more ribs, and the at least one fastening element receiving portion includes one or more slots at an upper end thereof for engageably receiving said one or more ribs. The at least one fastening element receiving portion may include a plurality of spaced apart fingers at an upper end therefore, said fingers defining the one or more slots.

Preferably, the glazing panel retention means and the bosses include engageable portions allowing the glazing panel retention means to locate against said bosses. The bosses may include one or more ribs, and the at least one fastening element receiving portion may include one or more slots at a lower end thereof for engageably receiving said one or more ribs. The at least one fastening element receiving portion may include a plurality of spaced apart fingers at a lower end thereof, said fingers defining the one or more slots.

Advantageously, at least one of the first and second door skins have one or more grooves formed therein for receiving a glazing panel sealant, thereby enabling the glazing panel to be sealed against at least one of the door skins.

According to a second aspect of the invention there is provided a door skin for a composite door, the door skin having an interior and an exterior door surface, in which the interior surface has one or more bosses formed therein for receiving a fastening element.

According to a third aspect of the invention there is provided a glazing panel retention means for retaining a glazing panel in a composite door with fastening elements that have an elongate body portion, the glazing panel retention means including at least one fastening element receiving portion having an elongate channel for receiving the elongate body portion of a fastening element, and a surface for engaging and retaining the glazing panel. Preferably, the glazing panel retention means is in the form a clip, most preferably having a single fastening element receiving portion.

Alternatively, a glazing panel retention means may include a plurality of fastening element receiving portions which are linked by connecting portions. For example, the glazing panel retention means may be in the form of a frame member including a plurality of fastening element receiving portions.

Advantageously, the surface for engaging and retaining the glazing panel extends from an upper end of the fastening element receiving portion and is substantially perpendicular to the elongate channel.

Preferably, the glazing panel retention means is moulded, most preferably injection moulded.

The glazing panel retention means may further include one or more slots at a lower end of the at least one fastening element receiving portion. The at least one fastening element receiving portion may include a plurality of spaced apart fingers at a lower end thereof, said fingers defining the one or more slots.

Preferably, there is provided a glazing panel retention means and a trim for the glazing panel, the glazing panel retention means and the trim including engageable portions allowing the trim to be retained in the glazing panel retention means. Advantageously, the trim includes a plurality of projections for locating in the elongate channels of one or more glazing panel retention means.

The trim may include one or more ribs, and the at least one fastening element receiving portion may include one or more slots at an upper end thereof for engageably receiving said one or more ribs. In these embodiments, the at least one fastening element receiving portion may include a plurality of spaced apart fingers at an upper end thereof, said fingers defining the one or more or slots.

According to a fourth aspect of the invention there is provided a glazed composite door including:

a composite door having a recess with an internal glazing panel receiving surface;

a glazing panel positioned in the recess and retained against the glazing panel receiving surface;

a plurality of fastening elements having an elongate body portion; and

at least one glazing panel retention means which retains the glazing panel in the recess and includes at least one fastening element receiving portion having an elongate channel for receiving the elongate body of a fastening element, and a surface for engaging and retaining the glazing panel;

in which the fastening elements are positioned in the elongate channels of the fastening element receiving portions and are secured internally in a portion of the composite door thereby clamping said surface of the at least one glazing panel retention means against the glazing panel so as to engage and retain the glazing panel in the recess. Preferably, at least a portion of the composite door is a moulded structure, and the moulded structure includes the internal glazing panel receiving surface against which the glazing panel is retained. Preferably, the moulded structure further includes one or more reinforcing sections into which the fastening elements can be secured. Thus, the reinforcing section is incorporated into the composite door during moulding. Most preferably, the reinforcing section is a metal.

In these embodiments, the composite door may be of the type in which an outer skin in moulded around in a core, and the outer skin may be moulded against the reinforcing section.

Preferably the composite door further includes a compressible member disposed between the glazing panel and the glazing panel retention means. The compressible member may be a foam layer. The compressible member may be in the form of a pad, strip or frame structure. The compressible member is advantageous because it protects the edge of the glazing panel and it compensates for any tolerance variations in the dimensions of the components. More than one compressible member may be used.

According to a fifth aspect of the invention there is provided a composite door, at least a portion of which is a moulded structure, wherein the moulded structure includes an internal glazing panel receiving surface against which a glazing panel can be retained and one or more reinforcing sections into which fastening elements can be secured in order to retain the glazing panel in place. Thus, the glazing panel receiving surface is formed as a moulding and the reinforcing section is incorporated into the composite door during moulding.

Preferably, the moulded structure defines a recess of which the glazing panel receiving surface forms a part.

The composite door may be of the type in which an outer skin is moulded around an inner core, wherein the outer skin is also moulded against the reinforcing section.

The reinforcing section may be at least in part disposed underneath the glazing panel receiving surface.

According to a sixth aspect of the invention, there is provided the use of glazing panel retention means to retain a glazing panel in a composite door with fastening elements that have an elongate body portion, in which the glazing panel retention means includes at least one fastening element receiving portion having an elongate channel for receiving the elongate body portion fastening elements and a surface for engaging and retaining the glazing panel.

Whilst the invention has been described above it extends to any inventive combination as set out or in the following description, drawings or claims,

### BRIEF DESCRIPTION OF THE DRAWING FIGURES

Embodiments of composite doors, door skins and glazing panel retention means in accordance with the invention will now be described, by way of example only, with reference to the accompanying drawings, in which:

FIG. 1 shows (a) a plan view of the exterior surface and (b) a plan view of the interior surface of a portion of a door skin of the invention;

FIG. 2 is a cross sectional view of a portion of a door skin of the invention;

FIG. 3 is a cross sectional view of a glazing panel being retained in a first embodiment of a composite door of the invention;

FIG. 4 is a perspective view of a trim and clip of the invention;

FIG. 5 is a cross sectional view of a glazing panel being retained in a second embodiment of a composite door of the invention; and

FIG. 6 shows a cross sectional view of a glazing panel being retained in a third embodiment of a composite door of the invention.

### DETAILED DESCRIPTION OF THE INVENTION

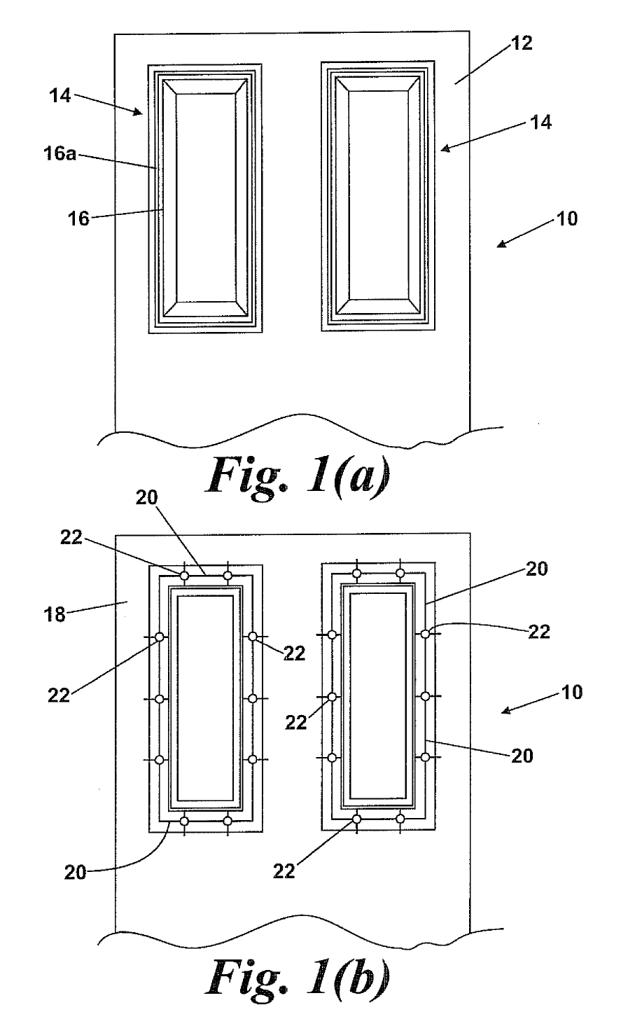

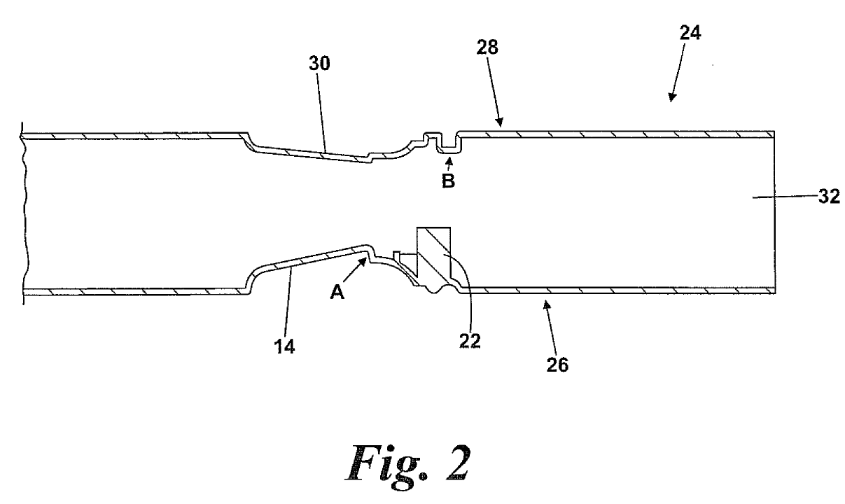

FIG. 1 shows a door skin 10 having on its exterior surface 12 panels 14 comprising concentric lip portions 16 as is well known in the art. As shown in FIG. 1(b) the interior surface 18 of the door skin 10 comprises a number of ribs 20 having a plurality of bosses 22 formed thereon. The ribs are in registry with the outer lip 16a of the panels 14. FIG. 2 shows a composite door 24 comprising a first door skin 26 which is generally of the type shown in FIG. 1, and shares many common features; identical numerals are used to denote such shared features. The composite door 24 further comprises a second door skin 28 which has panels 30 which are in registry with the panels 14 of the first door skin 26. The door skins 26, 28 are separated by a foam core 32, and are mounted on a door frame (not shown) in the conventional manner.

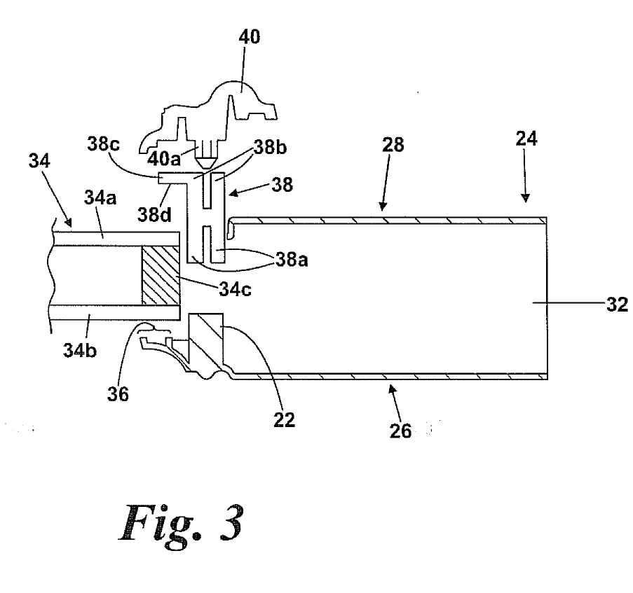

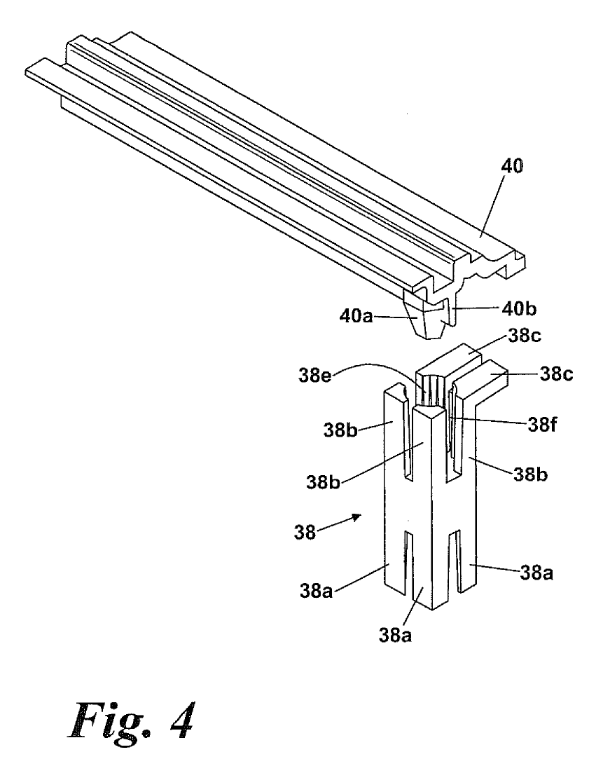

The composite door 24 shown in FIG. 2 is unglazed, but offers the facility for a glazing panel to be installed conveniently, quickly, and with an aesthetically pleasing final result. More particularly, glazing of the composite door 24 can be accomplished by removing the panels 14 and 30 at points A and B respectively, as shown in FIG. 2. FIG. 3 shows the installation of a glazing panel 34 in the composite door 24 of FIG. 2 once the panels14, 30 have been removed to provide a recess in which the glazing panel 34 can reside. The glazing panel 34 comprises two panes of glass 34a, 34b which are separated by a spacer frame 34c. The glazing panel 34 is introduced into the recess from the side of the second door skin 28, and abuts a rebate defined by the portion of the first door skin 26 shown at 36. A plurality of clips 38 are then used to secure the glazing panel 36 in position, the clips 38 locating over the bosses 22. A clip 38 is shown in FIG. 3 and comprises a plurality of lower fingers 38a, a plurality of upper fingers 38b and side protrusions 38c which depend perpendicularly from the uppermost portions of the upper fingers 38b and define a glazing panel retention surface 38d. The lower fingers 38a define slots which are engageable with the ribs 20 to secure the clip 38 against its corresponding boss 22. It might alternatively be possible to provide an arrangement in which the clip locates in a boss rather than over it. The clip is positioned so that when it is secured against its corresponding boss 22 the surface 38d abuts against the glazing panel 34. The clip 38 has an elongate central channel in which is received a fastening element having an elongate body portion (not shown) such a screw. The screw is fixed in the boss 22 so as to retain the clip 38 in place. A trim 40 is then secured in place by locating same in the clips 38. The location of the trim 40 in a clip 38 is shown in more detail in FIG. 4 which shows a projection 40a on the trim 40 which is positioned so as to be received in the elongate channel 38e of a clip 38. The trim 40 further comprises a rib 40b which is received by a 38f defined by upper fingers 38b of the clip 38. It is understood that the trim 40 comprises a plurality of projections 40a and ribs 40b which are spaced so as to correspond to the position of the clips when fitted to the bosses 22.

The door skins 26, 28 are very conveniently moulded in SMC, resulting in preformed bosses suitable for use in glazing. It is also possible to provide bosses at locations on a door skin suitable for fixing other hardware fixtures, such as letterboxes and door knockers. The composite door may be initially produced with no glazing (such as shown in FIG. 2). The provision of the bosses 22 enable glazing to be accomplished easily should this be desired, and it is advantageous that, by providing a door having a number of panels, each of which have associated bosses 22 incorporated therein, it is possible to provide a choice of locations in which glazing might be incorporated. Alternatively, the glazing might be incorporated in the composite door at the time of manufacture. In this instance, it is possible to mould the door skin so as to provide a suitable recess, i.e., the door skins may be moulded in the configuration shown in FIG. 3., and a glazing panel may be retained in the composite door using the methods described above with reference to FIG. 3. In another embodiment still, the composite door is glazed at the time of manufacture by another method, such as by press glazing. In this instance, the provision of the bosses is still highly advantageous, because should it subsequently become necessary to replace the glazing (for example if the glass was broken) it is convenient and straightforward to do so using the method of the present invention. This is a considerable advantage, because otherwise it would be necessary to replace the entire door.

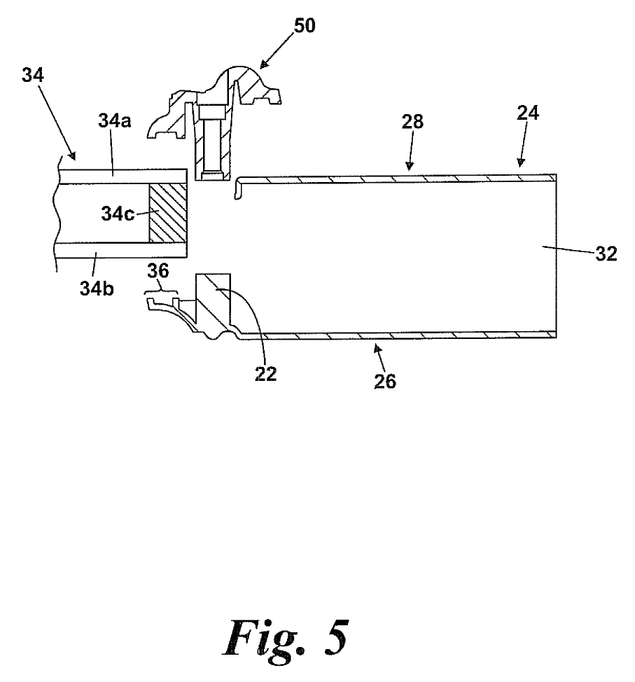

FIG. 5 depicts a further embodiment in which a recess is formed in a composite door 24 of the type shown in FIG. 3. The composite door 24 and the glazing panel 34 are identical to the composite door and glazing panel shown in the embodiment of FIG. 3, and identical numerals are used to denote common features. The second embodiment differs from the first embodiment in that, in place of the clip 38 and trim 40 combination, one half of a glazing cassette 50 of known construction is used. The glazing cassette frame member 50 abuts the boss 22 and glazing panel 34, and receives fastening elements such as screws which are secured in the bosses 22 thereby clamping the glazing panel 34 in place.

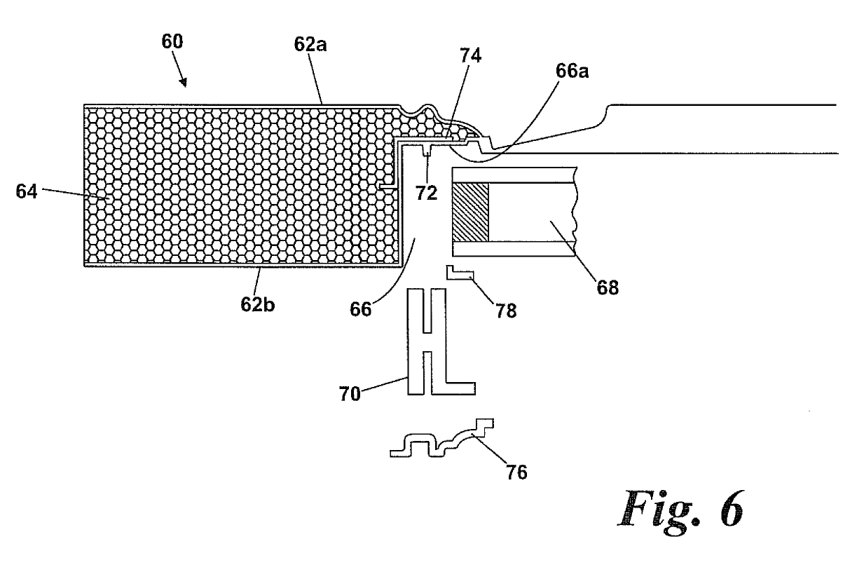

FIG. 6 shows a third embodiment of the invention which utilises a different construction of composite door. More particularly, the embodiment shown in FIG. 6 utilises a moulded composite door, shown generally at 60, in which a reinforcing anchor section 74 is moulded into a pre-formed glazing rebate portion 66a during a moulding process in which the door is formed. FIG. 6 depicts the moulded door which has a first face 62a and a second face 62b, and a core 64. The third embodiment is moulded to provide a recess 66 having the rebate portion 66a against which a glazing panel 68 is retained. The glazing panel 68 is retained in place against the rebate portion 66a using a plurality of clips 70 which are identical to the clips 38 shown in FIGS. 3 and 4. A rib 72 depends from the rebate portion 66a and the clip 70 is coupleable therewith. Each clip 70 receives a fastening element, such as a screw, having an elongate body portion, and the screws are secured in the composite door 60 through the rebate portion 66a. A portion of the generally L-shaped reinforcing section 74 is located beneath the rebate surface 66a, and the screws are fastened against this portion of the reinforcing section 74. The reinforcing section 74 can be formed from any suitable material, typically a metal such as steel. It is an advantageous aspect of the present invention that the reinforcing section 74 can be incorporated during the press moulding process. A suitable trim 76 is provided which is located in the clips 70 in the manner explained with reference to FIGS. 3 and 4. Optionally, a foam pad 78 provides an intermediate layer between the glazing panel 68 and the clip 70. The foam pad 78 is advantageous because it protects the edge of the glazing panel and it compensates for any tolerance variations in the dimensions of the components.

It is advantageous that doors of the type described with reference to FIG. 6 can be produced in a condition suitable for immediate glazing, without requiring any time consuming preparation processes such as cutting or milling a recess in the door.

1. A composite door including a first and a second door skin, each door skin having an interior and an exterior surface, in which the interior surface of at least the first door skin has one or more bosses formed therein for receiving a fastening element.

2. A composite door according to claim 1 in which the doors skins are moulded, and the one or more bosses are in the form of mouldings.

3. A composite door according to claim 2 in which the doors skins are moulded from sheet moulding compound (SMC).

4. A composite door according to claim 1 in which the one or more bosses are adapted to receive a threaded fastening element, preferably a screw or threaded insert.

5. A composite door according to claim 1 which is glazed, and further includes: a glazing panel disposed in a recess in the door; and at least one glazing panel retention means for retaining the glazing panel in the recess; in which the at least one glazing panel retention means is secured to a plurality of bosses in the first door skin by respective fastening elements.

6. A composite door according to claim 5 in which the interior surface of the first door skin has an aperture formed therein which aperture is surrounded by a glazing panel receiving surface against which the glazed panel is retained.

7. A composite door according to claim 5 in which the fastening elements have an elongate body portion and a glazing panel retention means includes at least one fastening element receiving portion having an elongate channel for receiving the elongate body portion of a fastening element, and a surface for engaging and retaining the glazing panel.

8. A composite door according to claim 7 including a plurality of glazing panel retention means in the form of a plurality of clips.

9. A composite door according to claim 7 in which a glazing panel retention means includes a plurality of fastening element receiving portions which are linked by connecting portions.

10. A composite door according to claim 9 in which the glazing panel is retained by a single glazing panel retention means in the form of a frame member including a plurality of fastening element receiving portions.

11. A composite door according to claim 5 further including a trim which is coupled to the glazing panel retention means in the vicinity of the second door skin.

12. A composite door according to claim 7 in which the glazing panel retention means and the bosses include engageable portions allowing the glazing panel retention means to locate against said bosses.

13. A composite door according to claim 12 in which the bosses include one or more ribs, and the at least one fastening element receiving portion includes one or more slots at a lower end thereof for engageably receiving said one or more ribs.

14. A composite door according to claim 13 in which the at least one fastening element receiving portion includes a plurality of spaced apart fingers at a lower end thereof, said fingers defining the one or more slots.

15. A glazing panel retention means for retaining a glazing panel in a composite door with fastening elements that have an elongate body portion, the glazing panel retention means including at least one fastening element receiving portion having an elongate channel for receiving the elongate body portion of a fastening element, and a surface for engaging and retaining the glazing panel.

16. A glazing panel retention means according to claim 15 in the form of a clip, preferably having a single fastening element receiving portion.

17. A glazing panel retention means according to claim 15 including a plurality of fastening element receiving portions which are linked by connecting portions.

18. A glazing panel retention means according to claim 17 in the form of a frame member including a plurality of fastening element receiving portions.

19. A glazed composite door including:
a composite door having a recess with an internal glazing panel receiving surface;
a glazing panel positioned in the recess and retained against the glazing panel receiving surface;
a plurality of fastening elements having an elongate body portion; and
at least one glazing panel retention means which retains the glazing panel in the recess and includes at least one fastening element receiving portion having an elongate channel for receiving the elongate body of a fastening element and a surface for engaging and retaining the glazing panel;
in which the fastening elements are positioned in the elongate channels of the fastening element receiving portions and are secured internally in a portion of composite door thereby clamping said surface of the at least one glazing panel retention means against the glazing panel so as to engage and retain the glazing panels in the recess.

20. A glazed composite door according to claim 19 in which at least a portion of which is a moulded structure, and the moulded structure includes the internal glazing panel receiving surface against which the glazing panel is retained.

21. A glazed composite door according to claim 20 in which the moulded structure further includes one or more reinforcing sections into which the fastening elements can be secured.

22. A composite door according to claim 19 further including a compressible member disposed between the glazing panel and the glazing panel retention means.

23. A composite door, at least a portion of which is a moulded structure, wherein the moulded structure includes an internal glazing panel receiving surface against which a glazing panel can be retained, and one or more reinforcing sections into which fastening elements can be secured in order to retain the glazing panel in place.

24. A composite door according to claim 23 wherein the moulded structure defines a recess of which the glazing panel receiving surface forms a part.

25. A composite door according to claim 23 in which the reinforcing section is at least in part disposed underneath the glazing panel receiving surface.

26. A door skin for a composite door, the door skin having an interior and an exterior door surface, in which the interior surface has one or more bosses formed therein for receiving a fastening element.

27. A method of retaining a glazing panel in a composite door including the steps of:
providing a plurality of fastening elements that have an elongate body portion;
providing one or more glazing panel retention means which each include at least one fastening element receiving portion having an elongate channel for receiving the elongate body portion of a fastening element and a surface for engaging and retaining the glazing panel;
engaging the glazing panel with said surfaces of the one or more glazing panel retention means; and
fastening the one or more glazing panel retention means to the composite door using the plurality of fastening elements.
